(19) United States
(12) Patent Application Publication
(10) Pub. No.: US 2006/0204687 A1
(43) Pub. Date: Sep. 14, 2006

(54) Ink-jet recording sheet

(75) Inventors: Toshihiko Iwasaki, Tokyo (JP); Keiji Ohbayashi, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KONICA MINOLTA PHOTO IMAGING, INC., Tokyo (JP)

(21) Appl. No.: 11/216,287

(22) Filed: Aug. 31, 2005

(30) Foreign Application Priority Data
Oct. 28, 2004 (JP) 2004-313637

(51) Int. Cl. B41M 5/00

(52) U.S. Cl. 428/32.34

(57) ABSTRACT

A ink-jet recording sheet comprising on a support an ink absorptive layer containing minute silica particles, hydrophilic binder and water-soluble multivalent metal compounds; wherein said ink absorptive layer is composed of at least tow layers, and the peak of distribution of the amount of the water-soluble multivalent compounds in the depth direction is located within 10 μm from the uppermost surface, and the weight ratio of the water-soluble multivalent metal compounds to minute silica particles in the uppermost layer of the ink absorptive layer, and the dried coating thickness of the uppermost-layer, have specific ranges.

### FIELD OF THE INVENTION

The present invention relates to a novel ink-jet recording sheet, and in more detail to a high quality ink-jet recording sheet which exhibits excellent ink absorbability and excellent bleeding resistance during extended storage, results in high image density, and minimizes density variation after printing.

### BACKGROUND OF THE INVENTION

In recent years, image quality of ink-jet recording has increasingly been improved and is approaching conventional photographic image quality. In order to achieve image quality comparable to conventional photographic image quality via ink-jet recording, improvements in performance have been attained for ink-jet recording sheets (hereinafter also referred simply to as recording sheets).

For example, created has been a recording sheet in which an ink absorptive layer is formed by applying hydrophilic binders such as gelatin or PVA onto an extremely smooth support. Recording sheets of this type absorb ink utilizing swellability of binders and are called swelling type ink-jet recording sheets. The above swelling ink absorptive layer features high transparency and efficient color formation due to the use of water-soluble resins as a constituting binder. However, ink after printing is not dried as desired. Further since formed images and layers are readily affected by water, the resulting waterfastness suffers. Specifically, since the printing rate of current ink-jet printers increases, in swelling type ink-jet recording sheets, ink absorption due to swelling of binders does not match the ejection amount nor rate of the ink. As a result, problems occur in terms of high speed printing adaptability due to excess ink and mottling.

On the other hand, a void type ink-jet recording sheet provided with a porous layer having a minute void structure which incorporates a extremely smooth support having thereon minute inorganic particles and hydrophilic polymers exhibits high glossiness, results in bright colors, as well as exhibits excellent ink absorbability and excellent drying properties. As a result, a void type ink-jet recording sheet is becoming one of the sheets which result in image quality nearest the conventional photography. Specifically, when using non-water absorptive supports, cockling, or so-called “wrinkling” does not result after printing, which tends to occur in water absorptive supports, and it is possible to maintain an extremely smooth surface, whereby it is possible to produce higher quality prints.

The void type recording sheet exhibits high ink absorbability and high speed drying properties. On the other hand, being affected by the refractive index of minute inorganic particles, the resulting layer transparency is lower than that of swelling type recording sheets. As a result, problems occur in which color formation is not efficient. In methods to enhance color formation of the void type recording sheets, it is important to realize a method to enhance the layer transparency and to realize a method in which dyes in ink are fixed at a higher portion. Since the former is automatically limited due to the refractive index of minute inorganic particles, it is more important to achieve improvements in the latter method.

To the present, various investigations have been conducted to overcome the above drawbacks of void type recording sheets. A commonly employed method is one in which anionic dyes are securely immobilized via combination with cationic substances which are incorporated into the porous layer. However, the simple incorporation of the cationic substances into the porous layer makes it difficult to fix dyes in the upper portion due to cationic substances. being present in the entire porous layer, whereby the desired color formation efficiency has not been achieved.

Japanese Patent Publication Open to Public Inspection (hereinafter referred to as JP-A) No. 2001-287451 describes a water-soluble salt selected from the group consisting of an aluminum salt, a magnesium salt, sodium salt, a potassium salt, and a zinc salt, being incorporated into an uppermost layer, whereby high density and preferred color reproduction are obtained by fixing coloring components of pigment ink in the surface layer portion of the ink receptive layer.

Further, JP-A No. 2002-160442 describes the following. Multilayer coating of at least two layers is performed employing a liquid coating composition incorporating zirconium compounds or aluminum compounds in a relatively small amount which is applied onto the portion near the support, and also employing a liquid coating composition incorporating zirconium compounds or aluminum compounds in a relatively large amount which is applied onto portions more remote from the support. Alternatively, zirconium compounds or aluminum compounds are overcoated onto the previously formed ink absorptive layer, and via impregnation, the zirconium compounds or aluminum compounds are allowed to be present in a higher amount in the remote portions from the support, whereby it is possible to minimize bleeding and to achieve higher image density.

Further, JP-A No. 2000-351267 describes that absorbability and fixability of pigment ink are improved in such a manner that a layer, employing a liquid coating composition at a pH of 3-11, incorporating alumina particles of an average particle diameter of 10-200 nm or oxide particles such as silica particles, the surface of which is processed with aluminum salts, is applied onto a porous ink receptive layer incorporating boehmite. JP-A No. 2001-328340 describes that waterfastness and lightfastness are improved by incorporating bivalent or higher valent water-soluble metal salts into a colorant receptive layer, while JP-A No. 2004-114459 describes that a layer incorporating colloidal silica, as a main component, the surface of which is modified to be cationic, is provided on an ink receptive layer and at the farthest portions from the support, whereby desired color formation, storage stability, drying properties and abrasion resistance of printed images are obtained employing the pigment ink.

In view of ink absorbability, the ink-jet recording sheet, described in above JP-A No. 2001-287451 employs water-soluble metal salts in an amount of 0.5-10 parts by weight with respect to 100 parts by weight of pigments such as silica. As shown in the example below, it is not possible to achieve high ink absorbability and dye fixability based on the above embodiment.

Further, as shown by the example below, the recording sheet described in above JP-A No. 2002-160442 does not also result in the desired bleeding resistance, the desired high density, and the desired storage stability due to the assumed reason in which the sufficient amount of zirconium compounds or aluminum compounds resulting in effective dye fixing is not sufficiently present on the available surfaces.

### SUMMARY OF THE INVENTION

According to the present invention, a ink-jet recording sheet is provided, the sheet comprising on a support an ink absorptive layer containing minute silica particles, hydrophilic binder and water-soluble multivalent metal compounds. Said ink absorptive layer is composed of at least tow layers, and the peak of distribution of the amount of the water-soluble multivalent compounds in the depth direction is located within 10 μm from the uppermost surface, and the weight ratio of the water-soluble multivalent metal compounds to minute silica particles in the uppermost layer of the ink absorptive layer, when both are converted to each of its oxides, is specified based on below formula (1), and the dried coating thickness of the uppermost layer is 2-20 percent of the total thickness of the ink absorptive layer.
3≦SiO₂/MO_{x/2}≦7 Formula (1)
wherein M represents a divalent or higher valent metal atom incorporated in water-soluble multivalent metal compounds, while x represents the valence of divalent or higher valent metal atom M.

In an embodiment, the ratio A/(A+B) of the weight of water-soluble multivalent metal compounds converted to its oxides in the uppermost layer (A) to the total weight of water-soluble multivalent metal compounds converted to its oxides (A+B) may at least 0.50.

In another embodiment, the water-soluble multivalent metal compound may be selected from water-soluble aluminum compounds and zirconium compounds.

### BRIEF DESCRIPTION OF THE DRAWINGS

FIG. 1 is a graph showing one example of a profile of the secondary ion intensity derived from a water-soluble multivalent metal compound determined by time of flight secondary ion mass spectrometry (TOF-SIMS).

FIG. 2 is a chart of distribution measurement in the depth direction of the ink absorptive layer of aluminum ions obtained by the TOF-SIMS measurement of Recording Sheet 2 employed as a comparative example.

FIG. 3 is a chart of distribution measurement of aluminum ions in the depth direction obtained by TOF-SIMS measurement of Recording Sheet 4 of the present invention.

### DETAILED DESCRIPTION OF THE INVENTION

The inventors of the present invention assumed that by localizing water-soluble multivalent metal compounds in the outermost surface region at a high concentration, it was possible to markedly enhance the image density which was a specific problem of the void type recording sheets, and further to minimize density variation after printing. Then it was discovered that by forming an outermost surface of the ink absorptive layer, employing a minute cationic particle dispersion which was prepared in such a manner that, for example, minute silica particles prepared employing a vapor phase method, were dispersed in the presence of water-soluble multivalent metal compounds. The pH being varied during. dispersion, made it possible to localize the water-soluble metal compounds within 10 μm from the outermost surface and it was also possible to obtain higher image density, whereby the present invention was achieved.

Then, analysis was performed employing time of flight type secondary ion mass spectrometry (TOF-SIMS), whereby it was possible to verify that the water-soluble multivalent metal compounds were localized in the outermost surface at a higher concentration.

Incidentally, in cases in which the weight ratio of the water-soluble multivalent metal compounds to minute silica particles, which is specified based on above formula (1) when both are converted to each of their oxides, exceeds 7, density enhancing effects are not realized, while in cases in which the ratio is less than 3, coagulation between layers occurs to degrade coatability, resulting in streaking.

Further, it was also discovered that by increasing the ratio of MO_{x/2} in the uppermost layer liquid coating composition and controlling the dried coating thickness to be 2-20 percent of the total thickness of the dried ink absorptive layer, it was possible to control the resulting thickness to at most 10 μm, and by controlling the above weight ratio, A/(A+B) to be at least 0.50, it was possible to achieve a preferable distribution of the amount of the water-soluble multivalent compounds.

Incidentally, in cases in which water-soluble multivalent metal compound containing solution was provided via impregnation or overcoating, it was clarified that the water-soluble multivalent metal compounds were not localized in the uppermost surface region.

The present invention is characterized in that the peak of the content distribution of the water-soluble multivalent metal compounds in the depth direction is located within 10 μm from the uppermost surface and the ratio of the oxide-converted weight of the water-soluble multivalent metal compounds to the oxide-converted weight of the minute silica particles, which are incorporated in the uppermost surface of the ink absorptive layer, satisfies the conditions specified in above formula (1).

It is possible to determine the amount of the water-soluble multivalent metal compounds in the depth direction of the ink absorptive layer, specified by the present invention, as follows. The side of an ink-jet recording sheet is sliced employing a microtome. Subsequently, in regard to the resulting sample, the distribution of the element or the secondary ion fragment specific to the multivalent metal in the depth direction is obtained employing an electron probe microanalyzer (EPMA) or a time of flight secondary ion mass spectrometer (TOF-SIMS).

In the present invention, confirmation whether water-soluble multivalent metal compounds are localized in the uppermost surface at a maximum concentration is effectively determined employing the above time of flight type secondary ion mass spectrography (TOF-SIMS). In regard to a secondary ion mass spectrography, reference may be made, for example, to TOF-SIMS: Surface Analysis by Mass Spectrometry (published by Surface Spectra Co.), edited by John C. Vickerman and David Briggs and “Niji Ion Shitsuryo Bunseki Ho (Secondary Ion Mass Spectrometry) (Hyomen Bunseki Gijutsu Sensho (Surface Analysis Technology Series)) (Maruzen).

A practical method for determination follows. An ink absorptive layer is cut employing a microtome so that a flat cross-section is exposed and the resulting ink absorptive layer is subjected to TOF-SIMS determination. Preferred as primary ions during the TOF-SIMS determination are metal ions such as Au⁺, In⁺, Cs⁺, or Ga⁺, and of these, preferred are In⁺ and G⁺. Incidentally, the preferable secondary ion to be detected is selected based on the secondary ion mass spectra, previously determined.

The primary ion acceleration voltage is preferably 20-30 kV. It is preferable that various adjustments are performed so that the beam diameter determined by a knife edge method is at most 0.25 μm. Exposure conditions such as beam current and exposure time are optional. Listed as a typical example of preferable determination conditions are a primary ion beam current of 0.9 nA and an exposure time of 20 minutes. Incidentally, since an ink-jet recording sheet or an ink absorptive layer results in low electric conductivity, it is preferable to suitably perform static neutralization by employing a neutralizing electron gun.

During the measurement, the primary ion beam is scanned in the range capable of measuring the entire region of the ink absorptive layer. It is possible to obtain an image of a chemical species in the ink absorptive layer based on the scanning position of the primary ion beam and the detected secondary ion. In the above scanning region, the mass spectra of the secondary ion is preferably measured at 256×256 points and the image of the chemical species is obtained by recording the intensity of the targeted secondary ion peak, based on the resulting mass spectra. Further, based on the resulting image, by integrating the peak intensity of the portion at the same thickness, it is possible to obtain a profile of the specified secondary ion in the thickness direction. Formation of the image and profile of the secondary ion is performed utilizing functions usually accompanied with software for data processing of a secondary ion mass spectrometer. In the present invention, it is possible to utilize the above functions.

In the present invention, in the above profile of a multivalent metal in the thickness direction, a portion in which the secondary ion intensity, derived from a multivalent metal in the ink absorptive layer, is 1.5 times its minimum value is specified as a multivalent metal existing portion. Further, the position and thickness of the ink absorptive layer are specified, in the same manner as for the multivalent metal ion, as a region in which metal ions incorporated in minute silica particles existing in the ink absorptive layer are detected. Incidentally, the position of each layer is a 50 percent position of the integrated ion intensity in the profile in the thickness direction.

In the present invention, the distribution amount of a multivalent metal compound in the thickness direction was practically determined under conditions of an ion species of In and an acceleration voltage of 25 kV, employing TRIFT-II, produced by Physical Electronics Co.

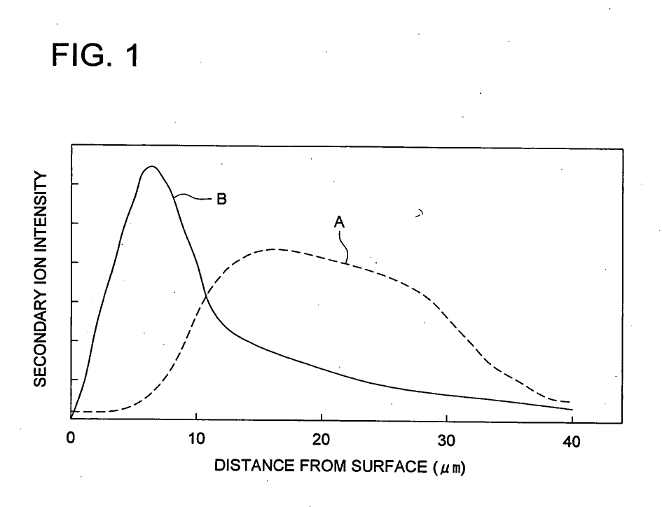

FIG. 1 is a graph showing an example of the profile of the secondary ion intensity due to a water-soluble multivalent metal compound, determined by TOF-SIMS.

In FIG. 1, the measured distance (in μm) from the outermost surface in the depth direction is plotted as the abscissa, while the intensity value of the secondary ion due to a multivalent metal compound determined at each depth position, employing TOF-SIMS, is plotted as the ordinate. Profile B is a typical example showing the state having a clear maximum value of the ion intensity within 10 μm. In Profile A, shown by a broken line,. of the ink absorptive layer which is prepared by incorporating a multivalent metal compound into a conventional ink absorptive layer liquid coating composition, the maximum value of the secondary ion intensity, due to the multivalent metal compound, is present in the interior (in FIG. 1, at a depth of approximately 15 μm). As a result, ink deposited onto the outermost surface is fixed in the interior of the ink absorptive layer, whereby it is not possible to achieve high image density.

Contrary to the above, in Profile B of the ink absorptive layer according to the present invention in which the ink absorptive layer is composed of at least two layers, and the outermost layer incorporates multivalent metal compounds at a higher concentration, the maximum value of the secondary ion intensity, due to the multivalent metal compound, is present within 10 μm (in FIG. 1, at a position of a depth of approximately 6 μm) from the uppermost surface. As a result, ink deposited onto the uppermost surface is fixed in the surface region of the ink absorptive layer, whereby it is possible to achieve high image density.

Listed as water-soluble multivalent metal compounds are chlorides, sulfates, nitrates, acetates, formates, succinates, malonates, and chloroacetates of metals such as aluminum, calcium,-magnesium, zinc, iron, strontium, barium, nickel, copper, scandium, gallium, indium, titanium, zirconium, tin, or lead. Of these, water-soluble salts of aluminum, calcium, magnesium, zinc, and zirconium are preferred due to the fact that their metal ions are colorless. Further, water-soluble aluminum and zirconium compounds are particularly preferred since they result in excellent bleeding resistance during extended storage.

Listed as specific examples of water-soluble aluminum compounds may be polychlorinated aluminum (basic aluminum chloride), aluminum sulfate, basic aluminum sulfate, aluminum potassium sulfate (alum), aluminum ammonium sulfate (ammonium alum), sodium aluminum sulfate, aluminum nitrate, aluminum phosphate, aluminum carbonate, aluminum polysulfate silicate, aluminum acetate, and basic aluminum lactate. Water solubility of water-soluble multivalent metal compounds, as described herein, means that they dissolve in water at 20° C. in an amount of at least 1 percent by weight, but more preferably at least 3 percent by weight.

In view of ink absorbing properties, the most preferred water-soluble aluminum compounds are basic aluminum chlorides at a basicity of at least 80 percent, and can be represented. by the molecular formula below.
[Al₂(OH)ₙCl₆₋ₙ]ₘ (on condition of 0<n<6 and m≦10

Basicity is represented by n/6×100 (in percent).

Specific examples of preferred water-soluble zirconium compounds include zirconyl carbonate, ammonium zirconyl carbonate, zirconyl acetate, zirconyl nitrate, zirconium acid chloride, zirconyl lactate, and zirconyl acetate. Of these, in view of bleeding resistance during storage over an extended duration, zirconium acid chloride and zirconyl acetate are particularly preferred.

Minute silica particles according to the present invention are preferably prepared employing wet process silica which is prepared employing a precipitation method or a gelling method while using sodium silicate as a raw material, or employing silica prepared employing a vapor phase method.

Commercially available wet process silica include, for example, FINE SEAL, a product of TOKUYAMA Corp. which is prepared employing a precipitation method, and NIPGEL, a product of Nippon Silica Industry Co., Ltd. which is prepared employing a gelling method. Precipitation method silica is characterized as silica particles which are formed in such a manner that primary particles of about 3- about 10 nm form secondary aggregates.

The lower primary particle diameter of wet process silica is not particularly limited. In view of stable production of silica particles, the diameter is preferably at least 3 nm, while in view of layer transparency, it is preferably at most 50 nm. Generally, wet process silica prepared employing a gelling method is more preferred than that prepared employing a precipitation method due to the fact that the primary particle diameter of the former tends to be less.

Vapor phase silica, as described herein, refers to silica which is synthesized by a combustion method employing silicon tetrachloride and hydrogen as raw materials, and is commercially available as the name, for example, AEROSIL SERIES, products of Nippon Aerosil Co., Ltd.

In the present invention, in view of achieving a higher void ratio and fewer coarse aggregates during production of minute cationic particle dispersion, a vapor phase method silica is particularly preferred to prepare minute silica particles. Further, vapor phase method silica is characterized in that it is possible to perform dispersion with less energy than wet process silica due to the fact that the secondary aggregates are formed under relatively weaker interaction than wet process silica.

Minute silica particles, prepared employing a vapor phase method, at an average primary particle diameter of 3-50 nm are preferred, while the diameter is more preferably at most 20 nm. When the average primary particle diameter is at most 50 nm, it is possible to achieve the desired high glossiness of recording sheets, and it is also possible to produce clearer and brighter images by minimizing a decrease in maximum density due to diffused surface reflection. The above average particle diameter of minute particles is determined as follows. Particles, as well as the cross-section or surface of a porous ink absorptive layer are observed employing an electron microscope and the particle diameter of many randomly selected particles is determined. Subsequently, the simple average value (number average) is calculated. Herein, the particle diameter is represented by the diameter of a circle which has the same area as the projective area of a particle.

Specifically preferred embodiments follow. Secondary or higher order particles are formed and a porous ink absorptive layer is then prepared. In that case, in view of preparing recording sheets which exhibit high ink absorbing capability and high glossiness, the average particle diameter is preferably 20-200 nm.

Further, it is preferable to control the moisture content of vapor phase method silica by storing minute silica particles, prepared employing a vapor phase method, at a relative humidity of 20-60 percent for at least three days.

The added amount of minute silica particles varies widely depending on the demanded ink absorption amount, the void ratio of the porous ink absorptive layer, and the. types of hydrophilic binders, but is commonly 5-30 g per m² of the recording sheet, but is preferably 10-25 g. The ratio of minute vapor phase method silica particle to hydrophilic binders is commonly 2:1-20:1, but is preferably 3:1-10:1.

As the added amount of minute silica particles increases, the ink absorption capacity also increases. However, degradation of performance such as formation of curling and cracking may tend to occur. Consequently, a method is preferred in which the capacity is increased by controlling the void ratio. The preferred void ratio is 40-75 percent. It is possible to control the void ratio according to the type of selected minute silica particles and binders, or based on the mixing ratio thereof, as well as the amount of other additives.

“Void ratio”, as described herein, refers to the ratio of the total void volume to the volume of the void layer. It is possible to calculate the void ratio based on the total volume of layer-forming materials and the layer thickness. Further, the total void volume is easily obtained by determining the water absorption amount.

The above minute cationic particle dispersion may be prepared as follows. In practice, minute vapor phase method silica particles, the surface of which is anionic, are added to an aqueous solution containing water-soluble multivalent metal compounds and the resulting mixture is dispersed (being a primary dispersion). Subsequently, pH controlling agents are added to the resulting primary dispersion and the resulting mixture is dispersed (being a secondary dispersion). Alternatively, a primary dispersion, which is prepared by dispersing the above minute vapor phase method silica particles in water, is blended with an aqueous solution containing water-soluble multivalent metal compounds and subsequently, pH controlling agents are added to the resulting mixture. Thereafter, the mixture is subjected to secondary dispersion.

Employed as a primary dispersion method may be any common ones known in the art. It is also possible to prepare a primary dispersion in such a manner that minute vapor phase method silica particles are subjected to suction dispersion into a dispersion medium composed mainly of water-soluble multivalent compounds and water, employing, for example, JET STREAM INDUCTOR MIXER, produced by Mitamura Riken Kogyo Inc. Subsequently, pH controlling agents are added to the above primary dispersion and the resulting mixture is dispersed to result in formation of minute particles, whereby it is possible to prepare a minute cationic particle dispersion, as described herein.

In the secondary dispersion method, it is possible to employ various prior art homogenizers such as a high speed rotary homogenizer, a media stirring type homogenizer (such as a ball mill or a sand mill), an ultrasonic homogenizer, a colloid mill homogenizer, a roller mill homogenizer, or a high pressure homogenizer. In order that the resulting minute vapor phase method silica particles in an aggregated state are efficiently dispersed, preferably employed are an ultrasonic homogenizer or a high pressure homogenizer.

Ultrasonic homogenizers apply ultrasonic waves of 20-25 kHz to the solid-liquid interface so that energy is concentrated, whereby dispersion is carried out. This results in very efficient dispersion and is suitable for preparing a small amount dispersion. On the other hand, in high pressure homogenizers, one or two homogenous valves, the gap of which can be controlled by screws or oil pressure, are provided at the exit of a high pressure pump fitted with 3 or 5 pistons, and the flow of liquid medium conveyed by a high pressure pump is narrowed by the homogenous valves creating high pressure and at the moment of passing the homogenous valves, any tiny aggregates are crushed. This system is particularly preferable for preparing a large amount dispersion, since it is possible to continually disperse a high volume liquid. The pressure applied to the homogenous valves is commonly 5-100 MPa. Dispersion may be completed in only one pass or repeated many times.

Incidentally, a minute cationic particle dispersion which is prepared in such a manner that water-soluble compounds are added to a slurry which is prepared by adding minute vapor phase silica into a water based medium followed by blending while stirring, results in an increase in viscosity or gelling, whereby it is not possible to prepare a targeted liquid coating composition.

It is preferable that the minute cationic particle dispersion is prepared by changing the pH of the primary dispersion, employing pH controlling agents. By such operation, a minute silica particle dispersion is prepared which has been subjected to uniform cation conversion. Further, it is possible to prepare a stable liquid coating composition exhibiting no variation in turbidity and viscosity during the following preparation process of an ink absorptive layer liquid coating composition. It is more preferable that a minute cationic particle dispersion is prepared by increasing the pH during dispersion. As a result, it is possible to enhance absorbability and fixability of the ink. The variation range of the pH is preferably 0.20-1.0. “During dispersion”, as described herein, refers to during primary dispersion, namely the period between the end of the primary dispersion and the end of the secondary dispersion.

Listed as acids of the pH controlling agents may, for example, be organic acids such as formic acid, acetic acid, glycolic acid, oxalic acid, propionic acid, malonic acid, succinic acid, adipic acid, maleic acid, malic acid, tartaric acid, citric acid, benzoic acid, phthalic acid, isophthalic acid, terephthalic acid, glutaric acid, gluconic acid, lactic acid, aspartic acid, glutamic acid, pimelic acid, or suberic acid, and inorganic acids such as hydrochloric acid, nitric acid, boric acid, and phosphoric acid. Listed as alkalis may be sodium hydroxide, potassium hydroxide, calcium hydroxide, ammonia water, potassium carbonate, sodium carbonate, sodium triphospahte, or triethanolamine. It is necessary to determine the added amount of each of these acids or alkalis, taking into account the degree of each of the acids and alkalis due to dispersion progression properties and dispersion stability.

Of the above pH controlling agents, preferred are boron compounds. Boron compounds, as described herein, refer to boric acids and salts thereof. Examples include borax, boric acids, and borates (for example, orthoborates, InBO₃, ScBO₃, YBO₃, LaBO₃, Mg₃(BO₃)₂, Co₃(BO₃)₂, diborates (for example, Mg₂B₂O₅ and CO₂B₂O₅), metaborates (for example, LiBO₂, Ca(BO₂)₂, NaBO₂, and KBO₂), tetraborates (for example, Na₂B₄O₇.10OH₂O), pentaborates (for example, KB₅O₈.4H₂O, Ca₂B₆O₁₁.7H₂O, and CsB₅O₅). An aqueous boron compound solution may incorporate a single boron compound or a plurality of them. Particularly preferred is a mixed solution of borax and boric acid. Each of boric acid and borax only forms an aqueous solution at a relatively low concentration. However, when both are mixed, it is possible to prepare an aqueous solution of a relatively high concentration, whereby it is possible to concentrate the dispersion. Further, advantages are exhibited in which it is possible to relatively freely control the pH depending on the mixture ratio of borax and boric acid.

In view of ink absorbability and layer strength, it is possible to simultaneously use cationic polymers having a quaternary ammonium salt group during the above dispersion. Particularly preferred are homopolymers of monomers having a quaternary ammonium salt group or copolymers of one or more copolymerizable monomers. When used in combination, it is preferable that boric compounds are simultaneously used during the second dispersion.

Listed as monomers having a quaternary ammonium salt group may, for example, be the compounds described in paragraphs [00281 and [0029] of JP-A No. 11-301096. The monomers which are copolymerizable with the above quaternary ammonium salt group are the compounds having an ethylenic unsaturated group, examples of which include example compounds described in paragraph [0031] of JP-A No. 11-301096.

Specifically, in cases in which cationic polymers having a quaternary ammonium salt group are copolymers, the ratio of the cationic monomers is preferably at least 10 mol percent, is more preferably at least 20 mol percent, but is most preferably at least 30 mol percent.

Monomers having a quaternary ammonium salt group may be employed singly or in combination of at least two types.

Listed as specific examples of cationic polymers having a quaternary ammonium salt group, which are preferably employed in the present invention, may be the compounds described in paragraphs [0035] -[0038] of JP-A No. 11-301096.

It is possible to prepare minute cationic particles via the addition of various additives. If desired, suitably employed are, for example, various nonionic or cationic surface active agents, antifoaming agents, nonionic hydrophilic polymers (polyvinyl alcohol, polyvinylpyrrolidone, polyethylene oxide, polyacrylamide, various types of saccharides, gelatin, and Pullulan, nonionic or cationic latex dispersions, water-compatible organic solvents (ethyl acetate, methanol, ethanol, isopropanol, n-propanol, and acetone), and inorganic salts.

Specifically, when water-compatible solvents are blended with an aqueous solution incorporating minute vapor phase method silica particles, the surface of which is anionic and water-soluble multivalent metal compounds, formation of tiny aggregates is preferably retarded. Such. water-compatible organic solvents are employed in a dispersion in the preferable range of 0.1-20 percent by weight, but in the more preferable range of 0.5-10 percent by weight.

In the present invention, the ratio of the water-soluble multivalent metal compounds to minute silica particles, when both are converted to each of its oxides, satisfies the conditions specified by Formula (1) below:
3≦SiO₂/MO_{x/2}≦7 Formula (1)
wherein M represents a divalent or higher valent metal atom incorporated in water-soluble multivalent metal compounds, while x represents the valence of divalent or higher valent metal atom M.

Water-soluble multivalent metal compounds, as described herein, are represented by MO_{x/2} in above Formula (1). Listed as divalent metal oxides are CaO, MgO, and ZnO, while listed as a trivalent metal oxide is, for example, Al₂O₃. Further, listed as a tetravalent metal oxide is, for example, ZrO₂. Based on MO_{x/2} according to Formula 1, in metal atoms carrying uneven valence, the number of oxygen atoms becomes a fraction. In such a case, according to accepted practice, it is expressed as a whole integer. For example, according to the representation method of Formula 1, aluminum oxide results in AlO_{1.5}. In this case, however, it is expressed as Al₂O₃.

Listed as hydrophilic binders employed in the present invention are, for example, polyvinyl alcohol, gelatin, polyethylene oxide, polyvinylpyrrolidone, casein, starch, agar-agar, carrageenan, polyacrylic acid, polymethacrylic acid, polyacrylamide, polymethacrylamide, polystyrene sulfonic acid, cellulose, hydroxyethyl cellulose, carboxymethyl cellulose, dextran, dextrin, Pullulan, and water-soluble polyvinyl butyral. These hydrophilic binders may be employed in combination of at least two types.

Hydrophilic binders preferably employed in the present invention are polyvinyl alcohols. Other than common polyvinyl alcohol which is prepared by hydrolyzing polyvinyl acetate, include modified polyvinyl alcohols such as polyvinyl alcohol, the terminal of which is anion-modified, anion-modified polyvinyl alcohol having an anionic group, or ultraviolet radiation crosslinking type modified polyvinyl alcohol.

The average degree of polymerization of polyvinyl alcohol prepared by hydrolyzing polyvinyl acetate is preferably at least 1,000, but more preferably 1,500-5,000. Further, the saponification ratio is preferably 70-100 percent, but is most preferably 80-99.5 percent.

Examples of cation-modified polyvinyl alcohol include those having a primary, secondary, or tertiary amino group, or a quaternary ammonium group in its main or side chain, as described in JP-A No. 61-10483, which are prepared by saponifying copolymers of ethylenic unsaturated monomers having a cationic group with vinyl acetate.

Listed as ethylenic unsaturated monomers having a cationic group may, for example, be trimethylol-(2-acrylamido-2,2.-dimethylethyl)ammonium chloride, trimethyl-(3-acrylamido-3,3-dimethylpropl)ammonium chloride, N-vinylimodazole, N-vinyl-methylimidazole, N-(3-dimethylaminopropyl) methacrylamide, hydroxyethyltrimethylammonium chloride, trimethyl-(2-methacrylamidopropyl)ammonium chloride, and N-(1,1-dimethyl-3-dimethylaminopropyl)acryl amide.

The ratio of the monomers containing a cation-modified group of cation-modified polyvinyl alcohol to vinyl acetate is commonly 0.1-10 mol percent, but is preferably 0.2-5 mol percent.

Listed as anion-modified polyvinyl alcohols are, for example, polyvinyl alcohol having an anionic group described in JP-A No. 1-206088, copolymers of vinyl alcohol with vinyl compounds having a water solubilizing group described in JP-A Nos. 61-237681 and 63-307979, and modified polyvinyl alcohol having a water solubilizing group described in JP-A No. 7-285265.

Further, listed as nonion-modified polyvinyl alcohols are, for example, polyvinyl alcohol derivatives which are prepared by being partially added with a polyalkylene oxide group, described in JP-A No. 7-9758 and block copolymers with vinyl compounds having a hydrophobic group, described in JP-A No. 8-25795.

Listed as ultraviolet radiation crosslinking type polyvinyl alcohol is, for example, modified polyvinyl alcohol having a photoreactive side chain, described. in JP-A No. 2004-262236.

Further, polyvinyl alcohols which differ in degree of polymerization and modification, as described above, may be employed in combination of at least two types.

In the ink-jet recording sheets of the present invention, it is preferable that in order to realize high glossiness and high void ratio without brittleness of the layers, polyvinyl alcohol is hardened by hardening agents.

Hardening agents which are usable in the present invention are commonly those having a group which reacts with polyvinyl alcohol or those which promote mutual reaction between different groups incorporated in polyvinyl alcohol. Listed as examples of such hardening agents are epoxy based hardening agents (for example, diglycidyl ethyl ether, ethylene glycol diglycidyl ether, 1,4-butanediol diglycidyl ether, 1,6-diglycidylcylcohexane, N,N-diglycidyl-4-glycidyloxyaniline, sorbitol polyglycidyl ether, and glycerol polyglycidyl ether); aldehyde based hardening agents (for example, formaldehyde and glyoxal); active halogen based hardening agents (for example, 2,4-dichloro-4-hydroxy-1,3,5-s-triazine); active vinyl based compounds (for example, 1,3,5-trisacryloyl-hxahydro-s-triazine, and bisvinyl sulfonylmethyl ether); boric acids and salts thereof, borax, aluminum alum, and isocyanate compounds. Of these, preferred are boric acids and salts thereof, epoxy based hardening agents, and isocyanate compounds.

Boric acids and salts thereof refer to oxygen acids having a boron atom as a central atom and salts thereof, specific examples of which include orthoboric acid, diboric acid, metaboric acid, tetraboric acid, pentaboric acid, octaboric acid, and salts thereof.

The used amount of hardening agents varies depending on the types of polyvinyl alcohol, hardening agents, and minute silica particles, as well as the ratio with respect to polyvinyl alcohol, and is commonly 5-500 mg, but is preferably 10-300 mg per g of polyvinyl alcohol.

During coating of the ink absorptive layer forming liquid coating composition according to the present invention, the above hardening agents may be added directly to the above liquid coating composition. Alternatively, they may be provided in such a manner that after coating the ink absorptive layer forming liquid coating composition (specifically incorporating no hardening agents) and subsequently drying the coating, a solution incorporating hardening agents is over-coated.

In the ink-jet recording sheet of the present invention, the thickness of the dried uppermost surface layer according to the present invention is preferably 2-20 percent with respect to the total thickness of the dried ink absorptive layer, but is.more preferably 5-15 percent. Namely, by coating at least two ink absorptive layers and incorporating the above water-soluble multivalent metal compounds into the uppermost layer of the ink absorptive layer at a high concentration, it is possible to realize an ink absorptive layer capable of forming a maximum value of the secondary ion intensity, due to the multivalent metal compound, in the region nearer the surface, as shown in FIG. 1.

It is preferable to incorporate surface active agents into the uppermost layer of the ink absorptive layer according to the present invention. Employed as surface active agents usable in the ink absorptive layer may be any of the cationic, betaine based, or nonionic hydrocarbon based, fluorine based, and silicone based surface active agents. Of these, in view of coating quality such as coating problem resistance and adaptability for simultaneous multilayer coating, preferred are cationic and betaine based surface active agents described in JP-A No. 2003-312134. The used amount of those surface active agents is preferably 0.0001-1.0 g/m², but is more preferably 0.001-0.5 g/m².

It is possible to incorporate cationic polymers into the ink absorptive layer according to the present invention.

Cationic polymers are those. which have primary, secondary, or tertiary amine, a quaternary ammonium salt group, or a quaternary phosphonium salt group in the main chain or the side chain, and prior art compounds for ink-jet recoding sheets are employed. In view of ease of the production, water-soluble ones are preferred.

Listed as examples of cationic polymers are polyethyleneimine, polyallylamine, polyvinylamine, dicyandiamidopolyalkylene polyamine condensation products, polyalkylene polyamine dicyandiamidoammonium salt condensation products, dicyandiamido formalin condensation products, epichlorohydrin-dialkylamine addition polymers, diallyldimethylammonium chloride polymers, diallyldimethylammonium chloride-SO₂ copolymers, polyvinylimidazole, vinylpyrrolidone-vinylimadazole copolymers, polyvinylpyridine, polyamidine, chitosan, cationic starch, vinylbenzyltimethylammonium chloride polymers, (2-methacroyloxyethyl)trimethylammonium chloride polymers, and dimethylaminoethyl methacrylate polymers.

Further, the examples also include cationic polymers described in Kagaku Jiho (Chemical Industry News), Aug. 15 and 25, 1998, and polymer dye fixing agents described on page 787 of “Kobunshi Yakuzai Nyumon (Introduction to Polymer Medicines.)” (page 787, published by Sanyo Chemical Industies, Ltd. 1992).

The average molecular weight of cationic polymers is preferably in the range of 2,000-500,000, but is more preferably in the range of 10,000-100,000.

The average molecular weight, as described in the present invention, refers to the number average molecular weight and also to the polyethylene glycol-converted value determined by gel permuation chromatography.

Further, in cases in which cationic polymers are previously incorporated into a liquid coating composition, they may be uniformly added to the liquid coating composition, and may also be added to the same in the form of composite particles prepared employing minute silica particles. Methods for preparing composite particles employing minute silica particles and cationic polymers include a method in which cationic polymers are blended with minute silica particles to result in adsorption and coverage, a method in which the resulting covered particles are coagulated to prepare higher order composite particles, and a method in which coarse particles prepared via blending are converted to more uniform composite particles employing a homogenizer.

Cationic polymers are commonly water-soluble due to the presence of a water solubilizing group. However, some of them are not soluble in water depending on compositions of copolymer components. In view of ease of the production, they are preferably water-soluble. However, even though they are barely soluble in water, it is possible to use them by dissolving them in water-compatible organic solvents.

Water-compatible organic solvents, as described herein, refer to organic solvents which are soluble in water in an amount of approximately 10 percent and include alcohols such as methanol, ethanol, isopropanol, or n-propanol;. glycols such as ethylene glycol, diethylene glycol, or glycerin; esters such as ethyl acetate and propyl acetate; ketones such as acetone and methyl ethyl ketone; and amides such as N,N-dimethylformamide. In this case, the used amount of organic solvents is preferably less than the water.

The used amount of cationic polymers is commonly in the range of 0.1-10 g, but preferably in the range of 0.2-5 g per m² of the ink-jet recording sheet.

It is possible to incorporate various types of additives, other than those described above, into the ink absorptive layer of the ink-jet recording sheets of the present invention, and into other layers provided as needed. It is preferable to specifically incorporate image retention enhancing agents such as ultraviolet radiation absorbing agents, antioxidants, and bleeding resistant agents.

Listed as these ultraviolet radiation absorbing agents, antioxidants, and bleeding resistant agents are alkylphenol compounds (including hindered phenols), alkylthiomethylphenol compounds, hydroquinone compounds, alkylated hydroquinone compounds, tocophenol compounds, thiodipenyl ether compounds, compounds having at least two thioether bonds, bisphenol compounds, O-, N-, and S-benzyl compounds, hydroxybenzyl compounds, triazine compounds, phosphonate compounds, acylaminophenol compounds, ester compounds, amide compounds, ascorbic acid, amine based antioxidants, 2-(2-hydroxyphenyl)Benzotriazole compounds, 2-hydroxybenzophenone compounds, acrylates, water-soluble or hydrophobic metal salts, organic metal compounds, metal complexes, hindered amine compounds (including so-called TEMPO compounds), 2-(2-hydroxyphenyl)1,3,5-triazine compounds, metal inactivating agents, phosphite compounds, phosphonite compounds, hydroxylamine compounds, nitrone compounds, peroxide scavengers, polyamide stabilizers, polyether compounds, basic auxiliary stabilizers, nucleation agents, benzofranone compounds, indolinone compounds, phosphine compounds, polyamine compounds, thiourea compounds, urea compounds, hydrazide compounds, amidine compounds, saccharide compounds, hydroxybenzoic acid compounds, dihydroxybenzoic acid compounds, and trihydroxybenzoic compounds.

Of these, preferred are alkylated phenol compounds, compounds having at least two thioether bonds, bisphenol compounds, ascorbic acid, amine based antioxidants, water-soluble or hydrophobic metal salts, organic metal compounds, metal complexes, hindered amine compounds, hydroxylamine compounds, polyamine compounds, thiourea compounds, urea compounds, hydrazide compounds, hydroxybenzoic acid compounds, and dihydroxybenzoic acid compounds.

Further incorporated may be various types of additives known in the art such as polystyrene, polyacrylic acid esters, polymethacrylic acid esters, polyacrylamides, polyethylene, polypropylene, polyvinyl chloride, polyvinylidene chloride, or copolymers thereof, urea resins, minute organic latex particles, for example, composed of melamine resins, liquid paraffin, dioctyl phthalate, tricresyl phosphate, minute oil droplets composed, for example, of silicone oil, various types of cationic or nonionic surface active agents, ultraviolet radiation absorbers described in JP-A Nos.-74193, 57-87988, and 62-261476, anti-discoloring agents described in JP-A Nos. 57-74192, 57-87989, 60-71785, 61-146591, 1-95091, and 3-13376, optical brightening agents described in JP-A Nos. 59-42993, 59-52689, 62-280069, 61-242871, and 4-219266, pH controlling agents such as sulfuric acid, phosphoric acid, citric acid, sodium hydroxide, potassium hydroxide, and potassium carbonate, antifoaming agents, antiseptic agents, thickeners, antistatic agents, or matting agents.

Supports usable in the present invention are not particularly limited. When water absorptive supports such as paper are employed, splashed water degrades their smoothness, whereby cockling tends to result. Further, water absorptive supports result in problems in which dyes, as well as zirconium compounds or aluminum compounds diffuse into them, whereby waterfastness is degraded, bleeding occurs, and image density is lowered. Accordingly, it is preferable that in view of exhibition of desired effects of the present invention, non-water absorptive supports are employed.

Listed as water absorptive supports usable in the present invention are, for example, common paper sheets, common fabric, as well as wooden sheets and boards. Of these, specifically, paper is most preferable since raw materials of paper exhibit excellent water absorption properties, and cost is an additional benefit. Employed as paper supports may be those which are prepared employing wood pulp as a main raw material, including chemical pulp such as LBKP and NBKP, mechanical pulp such as GP, CGP, RMP, TMP, CTMP, CNP, or PGW, and recycled fiber such as DIP. Further, if desired, effectively employed may be various fibrous substances such as synthetic pulp, synthetic fiber, and inorganic fiber.

If desired, it is possible to incorporate into the above paper supports, various types of conventional prior art additives such as sizing agents, pigments, paper strength enhancing agents, fixing agent, optical brightening agents, wet paper strengthening agents or cation-modifying agents.

It is possible to make paper supports in such a manner that fibrous substances such as wood pulp and various types of additives are blended, and the resulting mixture is subjected to paper production employing various paper producing machines such as a Fourdrinier paper machine, a cylinder paper machine, or a twin wire paper machine. Further, if desired, during paper production, it is possible to perform a size press treatment employing starch and polyvinyl alcohol, various coating treatments, or a calendering treatment in paper making machines.

Listed as preferable non-water absorptive supports are plastic resinous film supports and supports covered with a plastic resinous film on both sides of the paper sheet.

Listed as plastic resinous film supports are polyester film, polyvinyl chloride film, polypropylene film, cellulose triacetate film, and polystyrene film, as well as film supports prepared by lamination of those. It is possible to use those plastic resinous films which are transparent or translucent.

In the present invention, particularly preferred supports are papers covered with plastic resins on both sides, and the most preferred one is a support which is prepared by covering both sides of a paper sheet with polyolefin resin.

It is possible to produce ink-jet recording sheets employing a method in which constituting layers including an ink absorptive layer are individually or simultaneously applied onto a support employing a coating system suitably selected from common coating systems, and subsequently dried. Preferably employed as coating systems, are, for example, a roller coating method, a rod bar coating method, an air knife coating method, a spray coating method, and a curtain coating method, as well as a slide bead coating method and an extrusion coating method described in U.S. Pat. Nos. 2,761,419 and 2,761,791.

When at least two constituting layers are simultaneously coated, and the slide bead coating system is employed, the viscosity of each liquid coating composition is preferably in the range of 5-100 mPa·s, but is more preferably in the range of 10-50 mPa·s. Further, when curtain coating is employed, the above viscosity is preferably in the range of 5-1,200 mPa·s, but is more preferably in the range of 25-500 mPa·s.

Further, the viscosity of a liquid coating composition at 15° C. is preferably at least 100 mPa·s, is more preferably 100-30,000 mPa·s, is still more preferably 3,000-30,000 mPa·s, but is most preferably 10,000-30,000 mPa·s.

Preferable coating and drying methods are such that liquid coating compositions heated to 30° C. or higher are subjected to simultaneous multilayer coating, and thereafter, the resulting coating is temporarily cooled at 1-15° C. and dried at 10° C. or higher. It is preferable to perform preparation, coating, and drying of liquid coating compositions at equal to or lower than Tg of the thermoplastic resins so that the above resins incorporated in the surface layer do not film. More preferred drying conditions are at a wet bulb temperature of 5-50° C., and a layer surface temperature of 10-50° C. Further, in view of uniformity of the resulting coating, it is preferable to use a horizontal setting system as a cooling system immediately after coating.

Further, it is preferable that the above production processes include one in which storage is performed between 35 and 70° C. for 24 hours-60 days.

Heating conditions are not particularly limited as long as the temperature is between 35 and 70° C. and storage duration is 24 hours-60 days. Preferred examples include 3 days-4 weeks at 36° C., 2 days-2 weeks at 40° C., or 1-7 days at 55° C. By applying a thermal process, it is possible to enhance hardening reaction of water-soluble binders or crystallization of the same, resulting in the desired ink absorbability.

To improve adhesion to the ink absorptive layer, it is possible to provide a sublayer on the surface on the above ink absorptive layer side of the support. Sublayer binders are preferably hydrophilic polymers such as gelatin or polyvinyl alcohol, as well as latex polymers at a Tg of −30-60° C. These binders are employed in an amount in the range of 0.001-2 g per m² of recording media. In order to minimize static drawbacks, it is possible to incorporate into the sublayer in a small amount of antistatic agents, known in the prior art, such as cationic polymers in a small amount.

It is also possible to provide a back layer on the opposite surface of the ink absorptive layer of the above support to improve slip properties and static characteristics. Binders in the back layer are preferably hydrophilic polymers such as gelatin or polyvinyl alcohol, as well as latex polymers at a Tg of −30-60° C. Further, it is possible to incorporate antistatic agents such as cationic polymers and various types of surface active agents, as well as matting agents at an average particle diameter of about 0.5- about 20 μm. The thickness of the back layer is commonly 0.1-1 μm. When the back layer is provided to minimize curling, the thickness is commonly in the range of 1-20 μm. The back layer may be composed of at least two layers.

### EXAMPLES

The present invention will now be described with reference to examples, however the present invention is not limited thereto. Incidentally, “%” in the examples is % by weight, unless otherwise specified.

### Example 1

### Preparation of Recording Sheets

[Preparation of Recording Sheet 1]

(Preparation of Silica Dispersion D-1)

While stirring at 3,000 rpm, 400 L of Silica Dispersion B-1 (at a pH of 2.6, containing 0.5% ethanol) containing 25% of previously uniformly dispersed vapor phase method silica (AEROSIL 300, produced by Nippon Aerosil Corp.) of a primary particle diameter of approximately 0.007 μm and 0.6 L of an anionic optical brightening agent (UVITEX NFW LIQUID, produced by Ciba Specialty Chemicals Co.) were added at room temperature to 110 L of Aqueous Solution C-1 (at a pH of 2.5, containing 2 g of antifoaming agent SN381, produced by San Nobuko Co.) containing 12% Cationic Polymer HP-1, 10% of n-propanol, and 2% ethanol. Subsequently, 54 L of Aqueous mixture Solution Al (each at a concentration of 3% by weight) containing boric acid and borax at a weight ratio of 1:1 was gradually added while stirring.

Subsequently, the resulting mixture was dispersed under a pressure of 3 kN/cm², employing a high pressure homogenizer, produced by Sanwa Industry. Co., Ltd. The total volume was then brought to 630 L by the addition of pure water, whereby almost transparent Silica Dispersion D-1 was prepared. 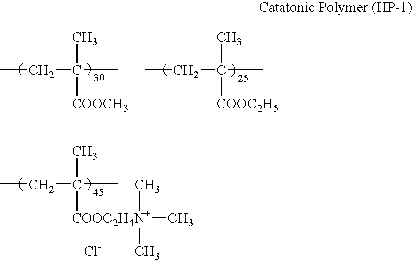
(Preparation of Silica Dispersion D-2)

Silica Dispersion D-2 was prepared in the same manner as above Silica Dispersion D-1, except that the anionic optical brightening agent was omitted.

(Preparation of Silica Dispersion D-3)

Silica Dispersion D-3 was prepared in the same manner as above Silica Dispersion D-2, except that Cationic Polymer HP-1 was replaced with an aqueous basic aluminum chloride solution (TAKIBINE #1500, produced by Taki Chemical Co., Ltd. containing 23.75% in terms of Al₂O₃, at a basicity of 83.5%).

The dispersion state of Silica Dispersions D-1, D-2, and D-3, prepared as above, was determined employing the method described in JP-A No. 11-321079. As a result, it was possible to confirm that very stable cation-converted composite particles were formed.

Further, each of Dispersions D-1, D-2, and D-3 was filtered employing a TCP-30 type filter produced by Advantec Toyo Co., Ltd. at a filtration accuracy of 30 μm.

(Preparation of Ink Absorptive Layer Liquid Coating Composition)

Each of the additives descried below was successively added to and mixed with each of the silica dispersions prepared as above, whereby each ink absorptive layer liquid coating composition for a porous layer was prepared. Incidentally, each of the added amounts was expressed as amount per liter of the liquid coating composition.

<First Layer Ink Absorptive Layer Liquid Coating Composition:
Lowermost Layer>

| | |
|---|---|
| Silica Dispersion D-1 | 650 ml |
| 8.0% aqueous polyvinyl alcohol (of an | 250 ml |
| average degree of polymerization | |
| and a degree of saponification of | |
| 88%) solution | |
| 4% aqueous surface active agent | 2.0 ml |
| (FUTERGENT 400S, produced by Neos | |
| Co., Ltd.) solution | |
| Pure water to make | 1000 ml |

<Second Layer Ink Absorptive Layer Liquid Coating
Composition>

| | |
|---|---|
| Silica Dispersion D-1 | 670 ml |
| 8.0% aqueous polyvinyl alcohol (of an | 240 ml |
| average degree of polymerization | |
| of 3,800 and a degree of | |
| saponification of 88%) solution | |
| Acryl copolymerization emulsion resin | 30 ml |
| (Vinysol 1083, produced by Daido | |
| Chemical Corp.) | |
| Pure water to make | 1000 ml |

<Third Layer Ink Absorptive Layer Liquid Coating Composition>

| | |
|---|---|
| Silica Dispersion D-2 | 630 ml |
| 8.0% aqueous polyvinyl alcohol (of an | 250 ml |
| average degree of polymerization | |
| of 3,800 and a degree of | |
| saponification of 88%) solution | |
| Pure water to make | 1000 ml |

<Fourth Layer Ink Absorptive Layer Liquid Coating
Composition: Lowermost Layer>

| | |
|---|---|
| Silica Dispersion D-2 | 630 ml |
| 8.0% aqueous polyvinyl alcohol (of an | 250 ml |
| average degree of polymerization | |
| 3,800 and a degree of saponification | |
| of 88%) solution | |
| 6% aqueous surface active agent | 3.0 ml |
| (QUARTAMIN 25P, produced by Kao | |
| Corp. | |
| 4% aqueous surface active agent | 1.0 ml |
| (FUTERGENT 400S, produced by Neos | |
| Co., Ltd.) solution | |
| Pure water to make | 1000 ml |

Each of the ink absorptive layer liquid coating compositions, prepared as above, was filtered by a TCPD-30 filter at a filtration accuracy of 20 μm, produced by Advantec Toyo, and subsequently filtered by a TCPD-10 filter.

(Preparation of Recording Sheets)

Subsequently, four ink absorptive layer liquid coating compositions, prepared as above, were simultaneously applied at 40° C. onto a paper support (RC paper) coated with polyethylene on both sides, employing a slide hopper type coater to result in the wet coating thickness described below.

<Wet Coating Thickness>

First Layer: 42 μm (coated SiO₂: 4.33 g/m²)
Second Layer: 42 μm (coated SiO₂: 4.57 g/m²)
Third Layer: 40 μm (coated SiO₂: 4.40 g/m²)
Fourth Layer: 40 μm (coated SiO₂: 4.40 g/m²)

Incidentally, the width and length of the above RC paper used as a support were about 1.5 m and bout 4,000 m, receptively, which was wound into a roll as described below.

The used RC paper was prepared as follows. The surface of a photographic base paper at a moisture content of 8 percent and a basic weight of 170 g was subjected to melt-extrusion coating with polyethylene incorporating 6% anatase type titanium dioxide to result in a thickness of 35 μm, while the rear surface was subjected to melt-extrusion costing with polyethylene to result in a thickness of 40 μm. After applying corona discharge on the surface side, a sublayer was applied onto the resulting surface so that the coated weight of polyvinyl alcohol (PVA235, produced by Kuraray Co., Ltd.) reached 0.05 g per m² on the RC paper. Subsequently, corona discharge was also applied onto the rear surface which was coated with a back layer incorporating about 0.4 g of styrene-acrylic acid ester based latex binders at a Tg of about 80° C., 0.1 g of an antistatic agent (being a cationic polymer), and 0.1 g of about 2 μm silica particles as a matting agent.

Drying, after coating the ink absorptive layer liquid coating compositions, was performed as follows. The temperature of the coating surface was lowered to 13° C. by passage through a cooling zone maintained at 5° C. over 15 seconds, and subsequently, drying was performed through a plurality of drying zones in which temperature was appropriately set. Thereafter, the resulting coating was wound into a roll, whereby Recording Sheet 1 was prepared. The total thickness of the dried ink absorptive layers, prepared as above, was 42.5 μm, while the thickness of the fourth layer (the uppermost layer) was 11.5 μm. Further, Recording Sheet 1 incorporated no water-soluble multivalent metal compounds in any layer.

(Preparation of Recording Sheet 2)

Recording Sheet 2 was prepared in such a manner that an aqueous basic aluminum chloride (TAKIBINE #1500, produced by Taki Chemical Co., Ltd., incorporating 23.75% as Al₂O₃ at a basicity of 83.5%) was overcoated onto the fourth layer of Recording Sheet 1, prepared as above, to result in a coated weight of 0.5 g/m² in terms of Al₂O₃. This corresponds to incorporation of water-soluble multivalent metal compounds by overcoating, described in JP-A No. 2002-160442.

(Preparation of Recording Sheet 3)

Recording Sheet 3 was prepared in the same manner as Recording Sheet 1, except that Silica Dispersion D-2 in the fourth layer was replaced with Silica Dispersion D-3. Incidentally, the coated SiO₂ weight in the fourth layer was 4.40 g/m², the Al₂O₃ coated weight was 0.5 g/m² (SiO₂/Al₂O₃=8.8), while the dried coating thickness was 11.5 μm (27 percent of the total dried layer thickness). A/(A+B) of Recording Sheet 3 was 1.0. This corresponds to the multilayer recording materials described in.JP-A No. 2002-160442.

(Preparation of Recording Sheet 4)

Recording Sheet 4 was prepared in the same manner as above Recording Sheet 3, except that Silica Dispersion D-3 employed in the fourth layer was replaced with a silica dispersion modified to SiO₂/Al₂O₃=4, further, the SiO₂ coated weight of the fourth layer was changed to 2.0 g/m², the Al₂O₃ coated weight was changed to 0.5 g/m², and the dried layer thickness was changed to 4.0 μm (9.4 percent of the total dried layer thickness). Incidentally, minute silica corresponding to 2.40 g/m² was equally divided by three, each of which was provided to each of the first layer-the third layer, whereby the total SiO₂ coated weight was maintained. A/(A+B) of Recording Sheet 4 was 1.0.

(Preparation of Recording Sheet 5)

Recording Sheet 5 was prepared in the same manner as Recording Sheet 1, except that Silica Dispersion D-2 in the third layer was replaced with Silica Dispersion D-3. Incidentally, the coated SiO₂ weight was 4.4 g/m², and the coated Al₂O₃ weight was 0.5 g/m² (SiO₂/Al₂O₃=8.8) of the third layer, while the dried layer thickness was 11.5 μm (27 percent of the total dried layer thinness). A/(A+B) of Recoding Sheet 5 was 0.

(Preparation of Recording Sheet 6)

Recording Sheet 6 was prepared in the same manner as above Recording Sheet 5, except that by employing the silica dispersion used in Recording Sheet 4, the coated SiO₂ weight changed to 2.0 g/m², the coated Al₂O₃ weight changed to 0.5 g/m² (SiO₂/Al₂O₃)=4 and the dried layer thickness changed to 4.0 μm (9.4 percent of the total dried layer thickness). Incidentally, minute silica corresponding to 2.40 g/m² was equally divided by three, each of which was provided to each of the first layer, the second layer, and the fourth layer, whereby the total SiO₂ coated weight was maintained. A/(A+B) of Recording Sheet 6 was 0.

(Preparation of Recording Sheet 7)

Recording Sheet 7 was prepared in the same manner as above Recording Sheet 4, except that an aqueous basic aluminum chloride solution (TAKIBINE #1500, produced by Taki Chemical Co., Ltd., containing 23.75% as Al₂O₃ at a basicity of 83.5%) was added to the ink absorptive layer liquid coating composition for the third layer to result in a coated weight of 0.05 g/m² in term of Al₂O₃. A/(A+B) of Recording Sheet 7 was 0.9.

(Preparation of Recording Sheet 8)

Recording Sheet 8 was prepared in the same manner as above Recording Sheet 4, except that an aqueous basic aluminum chloride solution (TAKIBINE #1500, produced by Taki Chemical Co., Ltd., containing 23.75% as Al₂O₃ at a basicity of 83.5%) was added to the ink absorptive layer liquid coating composition for the third layer to result in a coated weight of 0.75 g/m² in term of Al₂O₃. A/(A+B) of Recording Sheet 8 was 0.4.

(Preparation of Recording Sheet 9)

Recording Sheet 9 was prepared in the same manner as above Recording Sheet 1, except that an aqueous basic aluminum chloride solution (TAKIBINE #1500, produced by Taki Chemical Co., Ltd., containing 23.75% as Al₂O₃ at a basicity of 83.5%) was added to the ink absorptive layer liquid coating composition for the fourth layer to result in a coated weight of 0. 5 g/m² in term of Al₂O₃, while the coated SiO₂ weight was controlled to be 2.0 g/m², and the dried layer thickness was controlled to be 4.0 μm. Incidentally, minute silica particles corresponding to 2.40 g/m² was equally divided by three, each of which was provided to each of the first layer-the third layer, whereby the total coated SiO₂ weight was maintained. A/(A+B) of Recording Sheet 9 was 1.0.

(Preparation of Recording Sheet 10)

Recording Sheet 10 was prepared in the same manner as above Recording Sheet 1, except that an aqueous basic aluminum chloride solution (TAKIBINE #1500, produced by Taki Chemical Co., Ltd., containing 23.75% as Al₂O₃ at a basicity of 83.5%) was added just prior to coating via in-line to the ink absorptive layer liquid coating composition for the fourth layer to result in a coated weight of 0.5 g/m² in term of Al₂O₃. Incidentally, the coated SiO₂ weight of the fourth layer was controlled to be 2.0 g/m², and the dried layer thickness was controlled to be 4.0 μm, while minute silica particles corresponding to 2.40 g/m² was equally divided by three, each of which was provided to each of the first layer-the third layer, whereby the total coated SiO₂ weight was maintained. A/(A+B) of Recording Sheet 10 was 1.0.

(Preparation of Recording Sheet 11) Recording Sheet 11 was prepared in the same manner as above Recording Sheet 4, except that zirconyl acetate (ZIRCOSOL ZA, produced by Daiichi Kigenso Kagaku-Kogyo Co., Ltd.) was added just prior to coating via in-line to the ink absorptive layer liquid coating composition for the third layer to result in a coated weight of 0.08 g/m² in term of ZrO₂. A/(A+B) of Recording Sheet 11 was 0.86.

(Preparation of Recording Sheet 12)

Recording Sheet 12 was prepared in the same manner as above Recording Sheet 4, except that a silica dispersion controlled to SiO₂/Al₂O₃=20 was used in the fourth layer and the SiO₂ coated weight, the Al₂O₃ coated weight, and the dried layer thickness of the fourth layer changed to 2.0 g/m², 0.1 g/m², and 4.0 gm (9.4% of the total dried layer thickness), respectively. Incidentally, minute silica particles corresponding to 2.40 g/m² was equally divided by three, each of which was provided to each of the first layer-the third layer, whereby the total coated SiO₂ weight was maintained. A/(A+B) of Recording Sheet 12 is 1.0. Resulting Recording Sheet 12 corresponds to the recording sheet described in JP-A No. 2001-287451.

(Preparation of Recording Sheet 13)

Recording Sheet 13 was prepared in the same manner as above Recording Sheet 4, except that a silica dispersion controlled to SiO₂/Al₂O₃=2.5 was used in the fourth layer and the SiO₂ coated weight, the Al ₂O₃ coated weight, and the dried layer thickness of the fourth layer changed to 2.0 g/m², 0.8 g/m², and 4.0 μm (9.4% of the total dried layer thickness), respectively. Incidentally, minute silica particles corresponding to 2.40 g/m² was equally divided by three, each of which was provided to each of the first layer-the third layer, whereby the total coated SiO₂ weight was maintained. A/(A+B) of Recording Sheet 13 is 1.0.

(Preparation of Recording Sheet 14)

Recording Sheet 14 was prepared in the same manner as above Recording Sheet 4, except that a silica dispersion controlled to SiO₂/Al₂O₃=6.5 was used in the fourth layer and the SiO₂ coated weight, the Al₂O₃ coated weight, and the dried layer thickness of the fourth layer changed to 2.0 g/m², 0.308 g/m², and 4.0 μm (9.4% of the total dried layer thickness), respectively. Incidentally, minute silica particles corresponding to 2.40 g/m² was equally divided by three, each of which was provided to each of the first layer-the third layer, whereby the total coated SiO₂ weight was maintained. A/(A+B) of Recording Sheet 14 is 1.0.

(Preparation of Recording Sheet 15)

Recording Sheet 15 was prepared in the same manner as above Recording Sheet 4 except that a silica dispersion controlled to SiO₂/Al₂O₃=7.5 was used in the fourth layer, and the SiO₂ coated weight, the Al₂O₃ coated weight, and the dried layer thickness of the fourth layer changed to 2.0 g/m², 0.267 g/m², and 4.0 μm (9.4% of the total dried layer thickness), respectively. Incidentally, minute silica particles corresponding to 2.40 g/m² was equally divided by three, each of which was provided to each of the first layer-the third layer, whereby the total coated SiO₂ weight was maintained. A/(A+B) of Recording Sheet 15 is 1.0. Resulting Recording Sheet 15 corresponds to one which incorporates water-soluble multivalent metal compounds in a less amount than that of the present invention.

<<Evaluation of Characteristics of Recording Sheets>>

(Determination of Distribution of Multivalent Metal Compound in Ink Absorptive Layer)

Each of the recording sheets prepared as above was sliced employing a microtome, and the resulting cross-sectional portion of the ink absorptive layer was subjected to TOF-SIMS determination under conditions of In as ion species and an acceleration voltage of 25 kV employing TRIFT-II, produced by Physical Electronics Co., and the distribution of aluminum ions in the depth direction was determined. As a result, it was possible to confirm that in the recording sheets of the present invention, the maximum value of the secondary ion intensity derived from aluminum ions existed within 10 μm in the depth direction from the surface.

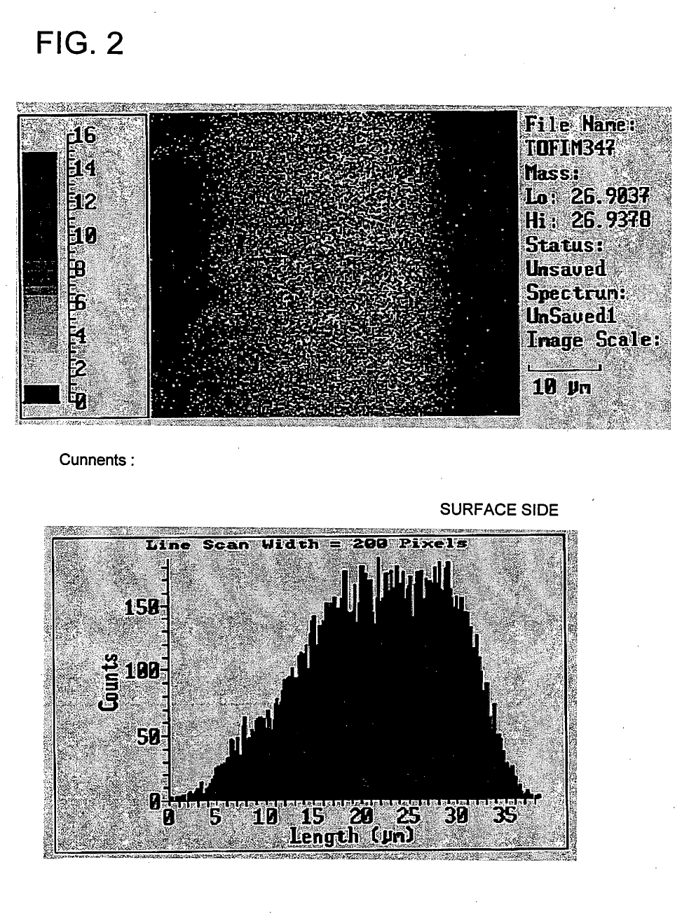

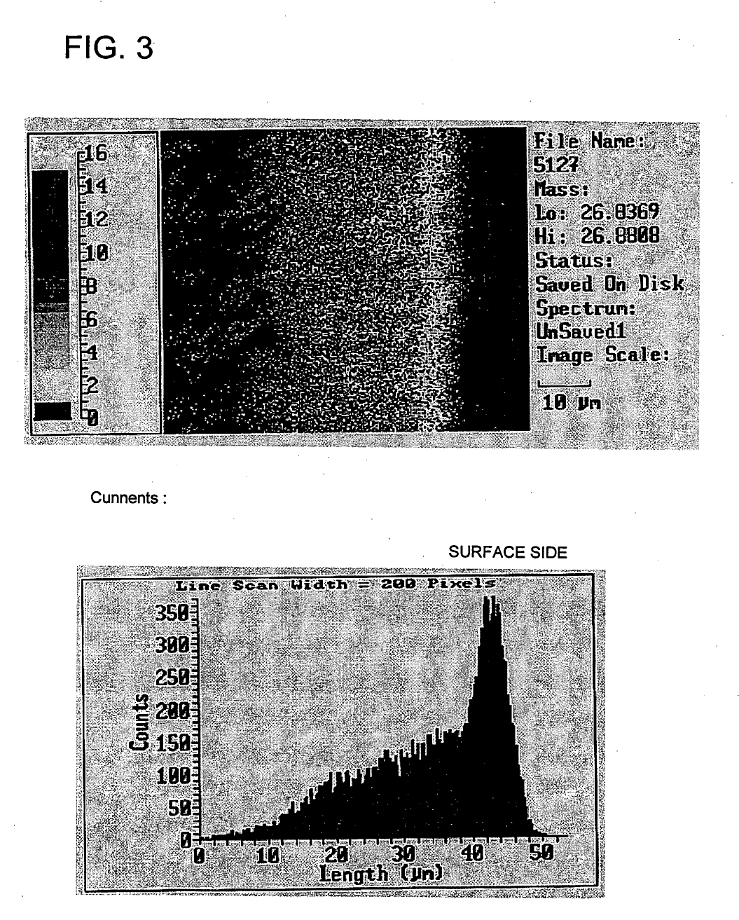

Each of FIGS. 2 and 3 is a chart of distribution measurement of multivalent metal compounds of Recording Sheet 2 of the comparative example and Recording Sheet 4 of the present invention as representative examples of determination of the distribution of multivalent metal compounds.

FIG. 2 shows a chart of distribution measurement of aluminum ions of the ink absorptive layer in the depth direction determined by TOF-SIMS. In FIG. 2, the outermost surface layer portion is in the right end of the chart, while Length 0 (μm) represents the support surface. Based on FIG. 2, it is seen that more secondary signals derived from aluminum ions are distributed in the interior of the ink absorptive layer, whereby more basic aluminum chloride is distributed in the interior.

FIG. 3 shows a chart of distribution measurement of aluminum ions of the ink absorptive layer in the depth direction of Recoding Sheet 4 of the present invention, determined by TOF-SIMS. In FIG. 3, in the same way as above, the outermost surface layer portion is in the right end of the chart, while Length 0 (μm) represents the support surface.

In Recording Sheet 4 of the present invention, a markedly large number of secondary ion signals derived from aluminum ions are generated in the region from the uppermost surface portion to the 10 μm deep portion, whereby it is seen that basic aluminum chloride is distributes in the surface region.

(Evaluation of Color Forming Properties)

By the use of genuine ink, black solid images were printed employing ink-jet printer PM-950C, produced by Seiko Epson Corp. After being allowed to stand for three hours for drying, the resulting black density was determined employing a densitometer and used as a scale for color forming properties.

(Evaluation of Bleeding Resistance after Extended Storage)

By the use of genuine ink, black lines at a line width of approximately 0.3 mm were printed on a blue solid image as a. background, employing ink-jet printer PM-950C, produced by Seiko Epson Corp at 23° C. and 55 percent relative humidity. After being allowed to stand for one hour for drying, it was inserted into a transparent clear file. The clear file was allowed to stand for one week at 40° C. and 80 percent relative humidity. The width of the black line prior to and after the above storage was determined employing a microdensitometer (width of the portion of a reflection density of 50 percent of the maximum density was designated as a line width). Subsequently, the variation ratio of the line width represented by the formula below was obtained and the resultant value was employed as a scale of bleeding resistance during extended storage. As this value decreases, bleeding resistance increases. The level for commercial viability is at most 130.

Line width variation ratio=(line width of the black line after storage/line width of the black line prior to storage)×100

(Evaluation of Ink Absorbability)

Solid blue images were printed at 23° C. and 80 percent relative humidity, employing an ink-jet printer PM-950C, produced by Seiko Epson Corp. Immediately after printing, the surface of solid images was rubbed with fingers and smudges on images was visually observed, while ink absorbability was evaluated based on the criteria below.
A: no image smudges were noted by rubbing with fingers
B: slight image smudges were noted on the rubbed portions
C: marked smudges resulted in the rubbed image.
   (Evaluation of Density Stability after Printing)

By the use of genuine inks, yellow, magenta, and cyan solid images were printed employing an ink-jet printer PM-950C produced by Seiko Epson Corp. and subsequently were allowed to stand at 23° C. and 55 percent relative humidity for 0.5 hour and 24 hours. Each of the yellow, magenta, and cyan densities after 0.5 hour and 24 hours were determined employing a reflection densitometer, and were represented by color density D(0.5) and color density D(24), respectively. Subsequently, D(24)/D(0.5)×100 was calculated of each of the color images and designated as a density decrease ratio. The average density decrease ratio D(ave) of each of the yellow, magenta, and cyan images was obtained and utilized as a scale of density stability after printing. As D(ave) approaches 100, density variation after printing decrease, resulting in excellent density stability.

The following table shows the evaluation results except the determination of the multivalent metal compound distribution of the ink absorptive layer.

| | Individual Evaluation Result | | | | | |
|---|---|---|---|---|---|---|
| | | Color | Bleeding | | | |
| Re- | | Forming | Resistance | | | |
| cording | | Property | (line width | Ink | Density | |
| Sheet | | (black | variation | Absorb- | Stability | Re- |
| No. | *1 | image) | ratio) | ability | (ΔD(ave)) | marks |
| 1 | none | 2.03 | 185 | A | 82.5 | Comp. |
| 2 | none | 2.08 | 155 | B | 85.8 | Comp. |
| 3 | none | 2.20 | 130 | C | 93.4 | Comp. |
| 4 | present | 2.38 | 125 | A | 98.0 | Inv. |
| 5 | none | 2.07 | 145 | C | 90.6 | Comp. |
| 6 | none | 2.15 | 135 | A | 92.8 | Comp. |
| 7 | present | 2.35 | 120 | A | 97.4 | Inv. |
| 8 | none | 2.18 | 120 | B | 93.7 | Comp. |
| 9 | present | 2.32 | 125 | A | 97.2 | Inv. |
| 10 | present | 2.33 | 125 | A | 96.9 | Inv. |
| 11 | present | 2.35 | 115 | A | 98.5 | Inv. |
| 12 | present | 2.25 | 130 | A | 95.8 | Comp. |
| 13 | present | 2.37 | 120 | B | 98.0 | Comp. |
| 14 | present | 2.34 | 125 | A | 97.0 | Inv. |
| 15 | present | 2.28 | 128 | A | 97.0 | Comp. |

Comp.: Comparative Example
Inv.: Present Invention
*1: Presence of the maximum value of the secondary ion intensity within 10 μm in the depth direction from the surface

As can clearly be seen form the results of the above table, recording sheets of the present invention were excellent in all of the color forming property, bleeding resistance during extended storage, ink absorbability, and density stability after printing.

### Example 2

Recording Sheets 16-19 were prepared in the same manner as Recording Sheet 4 of Example 1, except that instead of the aqueous basic aluminum chloride solution (TAKIBINE #1500, produced by Taki Chemical Co., Ltd., containing 23.79% in term of Al₂O₃, at a basicity of 83.5%), employed were basic aluminum lactate (TAKICERUM G-17L, produced by Taki Chemical Co., Ltd., at a basicity of 72%), zirconyl acetate (ZIRCOSOL ZA, produced by Daiichi Kigenso Kagaku Kogyo Co., Ltd.), zirconyl acid chloride (ZIRCOSOL ZC-2, produced by Daiichi Kigenso Kagaku Kogyo Co., Ltd.), and magnesium chloride, respectively, and were evaluated for each item employing the same methods described in Example 1. Each of Recording Sheets 16-18 were capable of exhibiting the excellent results equivalent to those of Recording Sheet 4 described in Table 1. Recording Sheet 19, in which magnesium chloride was employed as a water-soluble multivalent metal exhibited the color forming property and bleeding resistance in the same level as Recording Sheet 3, while results were obtained in which the ink absorbability and density stability, were the same as Recording Sheet 4.

What is claimed is:

1. A ink-jet recording sheet comprising on a support an ink absorptive layer containing minute silica particles, hydrophilic binder and water-soluble multivalent metal compounds; wherein
said ink absorptive layer is composed of at least tow layers, and the peak of distribution of the amount of the water-soluble multivalent compounds in the depth direction is located within 10 μm from the uppermost surface, and the weight ratio of the water-soluble multivalent metal compounds to minute silica particles in the uppermost layer of the ink absorptive layer, when both are converted to each of its oxides, is specified based on below formula (1), and the dried coating thickness of the uppermost layer is 2-20 percent of the total thickness of the ink absorptive layer.
3≦SiO₂/MO_{x/2}≦7 Formula (1)
wherein M represents a divalent or higher valent metal atom incorporated in water-soluble multivalent metal compounds, while x represents the valence of divalent or higher valent metal atom M.

2. The ink-jet recording sheet of claim 1, wherein the ratio A/(A+B) of the weight of water-soluble multivalent metal compounds converted to its oxides in the uppermost layer (A) to the total weight of water-soluble multivalent metal compounds converted to its oxides (A+B) is at least 0.50.

3. The ink-jet recording sheet of claim 1, wherein the water-soluble multivalent metal compound is selected from water-soluble aluminum compounds and zirconium compounds.

4. The ink-jet recording sheet of claim 2, wherein the water-soluble multivalent metal compound is selected from water-soluble aluminum compounds and zirconium compounds.

5. The ink-jet recording sheet of claim 1, wherein the minute silica particles are prepared employing a vapor phase method.

6. The ink-jet recording sheet of claim 2, wherein the minute silica particles are prepared employing a vapor phase method.

7. The ink-jet recording sheet of claim 1, wherein the hydrophilic binder is a polyvinyl alcohol.

8. The ink-jet recording sheet of claim 2, wherein the hydrophilic binder is polyvinyl alcohol.

9. The ink-jet recording sheet of claim 1, wherein the support is prepared by covering both sides of a paper sheet with polyolefin resin.

10. The ink-jet recording sheet of claim 2, wherein the support is prepared by covering both sides of a paper sheet with polyolefin resin.
